(19) United States
(12) Patent Application Publication
(10) Pub. No.: US 2006/0018089 A1
(43) Pub. Date: Jan. 26, 2006

(54) Notebook type keyboard apparatus

(76) Inventor: Chun-Chien Chou, Sinjhuang City (TW)

Correspondence Address: TROXELL LAW OFFICE PLLC, SUITE 1404, 5205 LEESBURG PIKE, FALLS CHURCH, VA, 22041, US

(21) Appl. No.: 10/896,908

(22) Filed: Jul. 23, 2004

(51) Int. Cl. G06F 1/16

(52) U.S. Cl. 361/683; 361/680

(57) ABSTRACT

A notebook type keyboard apparatus is disclosed. The apparatus comprises a keyboard coupled to a main body in the form of a notebook. Containing slots for firmly receiving a PDA or mobile phone are mounted on the keyboard. The handheld electronic apparatus is connected to a wireless transmission apparatus on the keyboard for inputting data. The main body comprises a bottom plate and a cover plate of the support rack mounted on its outside. The cover plate can be folded against the bottom plate, or unfolded for operation on a planar surface by the support of the support rack, so that the main body is treated as a support framework of input operation. Notepapers are mounted in the main body below the keyboard for handwriting the record. Therefore, an integrated data input apparatus is provided. It is easy to fold and set up this apparatus. When it is not in use, it conserves space, and is portable.

### BACKGROUND OF THE INVENTION

The present invention relates to a notebook type keyboard apparatus, and more particularly, to a keyboard apparatus connecting to a handheld electronic apparatus, for example, a PDA or a mobile phone, for inputting data, and can be folded to have a notebook form.

Nowadays, Personal Digital Assistant (PDA) is a popular portable electronic apparatus. Generally, this apparatus merely comprises a LCD screen and several control buttons but with no conventional typing type keyboard. When the user needs to input data, he usually uses a touch pan to input data by writing on a screen. But, this method is not suitable for masses of text input. Thus, an external keyboard is required for input operation. When it is in use, a connection mechanism is used to connect the keyboard with the PDA. When it is not in use, the keyboard can be separated from the PDA.

The conventional external keyboards are usually classified into handheld type and desk-top type. However, the button size of the handheld keyboard is too small. It is inconvenient for typing operation. When it is held by hand, if the connection mechanism between the keyboard and the PDA is poor, peeling off or weak signal will be induced by the sway of them. Another way is to mount the keyboard on a planar surface for using, but it is limited by the using place. Thus, the connection and setup method of the convention keyboard and the PDA is very inconvenient. Its input operation is limited by the structure of the keyboard, that is, it can be merely held by hand or mounted on the desk for operation. It is not suitable for using on the lap directly. Therefore, it provides with no mobility, and should be improved in use.

Although the PDA and the mobile phone can be connected to the external keyboard for recording and processing data, the conventional handwriting notebook is still not preventable. Thus, the user needs to carry a notebook, a handheld electronic apparatus, such as PDA or mobile phone, and an external keyboard at the same time, when he is out. In other words, several equipments, which are not integrated with one another, must be carried. Thus, it is inconvenient for carrying or using. Moreover, larger space will be occupied, since these equipments are not integrated with one another, and spread everywhere while not in use.

Furthermore, the current PDA in common use has various operation systems, all functions of these systems are usually printed on a function plate of the keyboard to adapt to these systems. Another deficiency of the prior art is that it is confusing.

### SUMMARY OF THE INVENTION

Consequentially, the main purpose of the present invention is to provide a notebook type keyboard apparatus by integrating a notebook with a keyboard, and treating the main body in the form of the notebook as a support framework for keyboard input operation. Moreover, several equipments are integrated to form a portable, foldable, easy set-up, and space-saving apparatus.

Another purpose of the present invention is to provide a notebook type keyboard apparatus, in which a containing slot for a handheld electronic apparatus and a wireless transmission apparatus are mounted thereon to connect to the handheld electronic apparatus for input operation.

Still another purpose of the present invention is to provide a notebook type keyboard apparatus, which has a replaceable function plate corresponding to various systems to prevent the user from confusion.

According to above purposes of the present invention, a notebook type keyboard apparatus is provided, which comprises a main body in the form of the notebook comprising a bottom plate and a cover plate, wherein the cover plate is folded or unfolded against the bottom plate, and a support rack is mounted on an outside of the cover plate to support the unfolded main body when it is set on a planar surface whereby the main body is a support framework.

A keyboard is pivotally mounted inside the main body, wherein the keyboard comprises a button region, a plurality of containing slots for the handheld electronic apparatuses, a wireless transmission apparatus, and a function plate. Each containing slot is used for firmly mounting a handheld electronic apparatus, such as PDA or mobile phone. The wireless transmission apparatus is a infrared ray transmission apparatus, which comprises a transmission line and an emitter, wherein the transmission line is fixed in a trench mounted on an edge of the cover plate to fix an emission direction of the emitter mounted on a front end of the transmission line to enable a receiver of the handheld electronic apparatus to successfully receive signal. A bracket is pivotally mounted on an interior surface of the cover plate, wherein the bracket can be rotated pivotally to provide the handheld electronic apparatus with different choices of setting method, and can be used for supporting a specific type handheld electronic apparatus.

The bottom plate is constituted by pivotal connection of a base plate and a backbend plate. The backbend plate can be bent back to a backside of the cover plate to lean the support rack against the backbend plate whereby a larger and steadier bottom support surface is formed by using the base plate and the backbend plate. Thus, the main body can be put on the lap for operation.

Numerous notepapers are mounted on the main body below the keyboard, a record can be written on the notepapers by pivotally and upwardly rotating the keyboard to clasp the cover plate.

Whereby, the present invention provides the functions of handwriting the note and inputting the record via the keyboard. These aforementioned functions are integrated to form a unitary portable keyboard apparatus. It is easy to set it up for using. When it is not in use, it can be easy folded to save space and provide with practicability.

A preferred embodiment is illustrated for detail description of the specific structures and operation ways of the present invention.

### BRIEF DESCRIPTION OF THE DRAWINGS

FIG. 1 is a perspective view showing an outward appearance of an unfolded main body of the present invention.

FIG. 2 is a schematic side view of FIG. 1 of the present invention.

FIG. 3 is a schematic view of a mounted PDA of the present invention.

FIG. 4 is a schematic diagram showing the use of the bracket to support a PDA.

FIG. 5 is a schematic diagram showing the use of notepapers by overturning the keyboard to fold up and clasp the cover plate of the present invention.

FIG. 6 is a schematic diagram showing the operation on the lap by bending back the bottom plate of the present invention.

FIG. 7-1 is a front perspective view of a folded main body of the present invention.

FIG. 7-2 is a bottom perspective view of a folded main body of the present invention.

FIG. 8 is a schematic view showing the use status of simultaneously connecting to two handheld electronic apparatuses in accordance with the present invention.

FIG. 9 is diagram showing the setting of a bluetooth communication apparatus of the preferred embodiment.

FIG. 10-1 shows another method for supporting the main body of the present invention.

FIG. 10-2 shows another method for supporting the main body of the present invention.

FIG. 10-3 shows another method for supporting the main body of the present invention.

FIG. 10-4 is a schematic diagram showing the folded status of FIG. 10-3.

### DETAILED DESCRIPTION OF THE PREFERRED EMBODIMENT

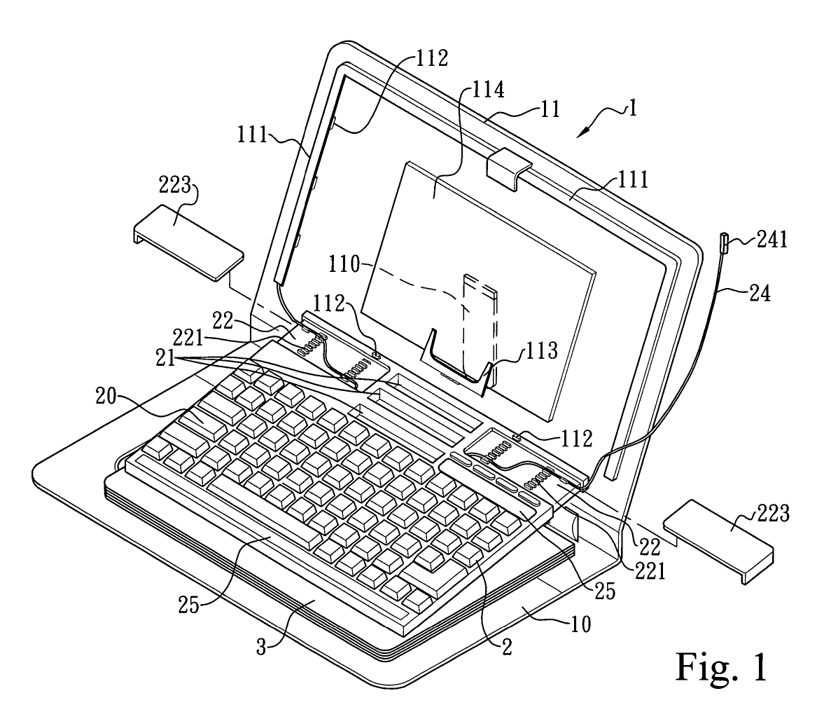

Referring to FIG. 1 through FIG. 3, which are a perspective view showing an outward appearance, a schematic side view, and a schematic view of a mounted PDA of an unfolded main body of the present invention respectively. The present invention comprises a main body 1 in the form of a notebook. The main body 1 comprises a bottom plate 10 and a cover plate 11, wherein a support rack 110 is pivotally mounted at an outside of the cover plate 11. The cover plate 11 can be folded and unfolded against the bottom plate 10. When they are in an unfolded condition, the support rack 11 can be expanded by rotation to support the cover plate 11 for setting the main body 1 on a surface of the desk to facilitate the operation.

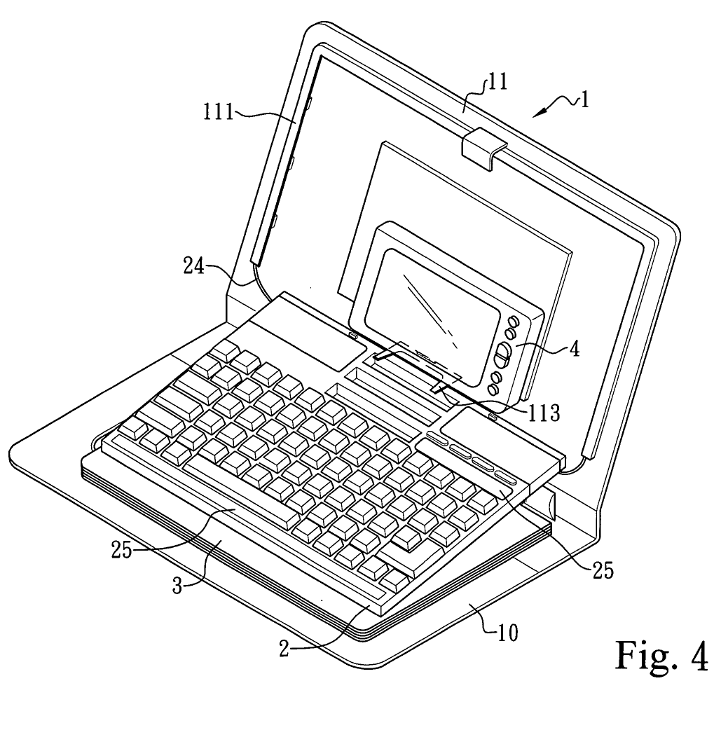

A thin type keyboard 2 having a button region 20 formed thereon is pivotally mounted inside the main body 1. A plurality of containing slots 21 are mounted at a front end of the button region 20 to fixedly hold a handheld electronic apparatus, for example, a PDA 4 or a mobile. The support provided by the cover plate 11 enable the handheld electronic apparatus to lean against the cover plate 11. The containing slots 21 are arranged front to rear to provide the placements with various angles. The handheld electronic apparatus can be mounted in the containing slots 21 or leaned thereon to treat the containing slot 21 as a support slot. A bracket 113 is pivotally mounted on an interior surface of the cover plate 11. The bracket 113 is folded by upward rotation, or rotated to have a horizontal plane for supporting a specific type handheld electronic apparatus such as horizontal rectangular PDA 4 or mobile phone, as shown in FIG. 4. A slip-proof pad 114 is mounted on a surface of the cover plate above the bracket 113 to enable the handheld electronic apparatus to lean against the slip-proof pad 114 for providing with a steadier installment.

A containing space 22 for an infrared ray transmission line is mounted on one side or both sides of the aforementioned containing slots 21, wherein a plurality of outstanding wedges 221 and a connector (not shown) are mounted in the containing space 22, and a cover 223 for coverage is mounted above the containing space 22. A trench 111 having a plurality of fixers 112 is mounted on an inside edge of the cover plate 11. One terminal of the infrared ray transmission line 24 is coupled with the connector in the containing space 22. The line body is fixed in the trench 111 so that a transmitter 241 on the other terminal of the infrared ray transmission line 24 can be fixed to one of these fixers 112. By using these fixers 112, the infrared ray transmitter 241 can be fixed to different fixers 112 according to different location of a receiver of the PDA 4. The redundant line body can be coiled up by using the wedges 221 of the containing space 22. Fixers 112 of the infrared ray transmitter 241 are also mounted at a front end of the containing space 22 and a front end of the containing slots 21 to enable the receiver on the bottom of the handheld electronic apparatus mounted on the bracket 113 to receive an infrared ray signal.

Function plates 25 are mounted on an upper side and a lower side of the button region 20. These function plates can be replaced to comply with various systems, for example, Palm OS, PocketPC, Symbian OS, Microsoft Smartphone, etc. When the system is switched, the function plates 25 can be replaced to prevent the user from confusion caused by printing functions of all systems in the same place.

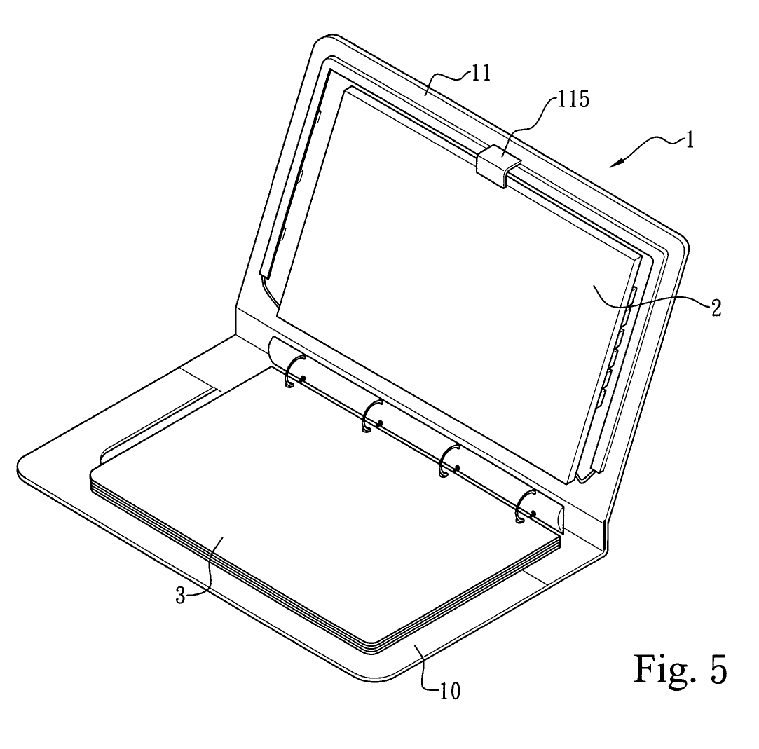

Referring to FIG. 5, which is a schematic diagram showing the use of notepapers by overturning the keyboard to fold up and clasp the cover plate of the present invention. Numerous notepapers are mounted on the bottom plate 10 of the main body 1 below the keyboard 2. A binder 115 is mounted on the interior surface of the cover plate 11. When it is needed to use the notepapers 3 for writing a record down, the keyboard 2 can be rotated pivotally and upwardly to the cover plate 11, and clasped by the binder 115, so that the notepapers can be treated as a notebook.

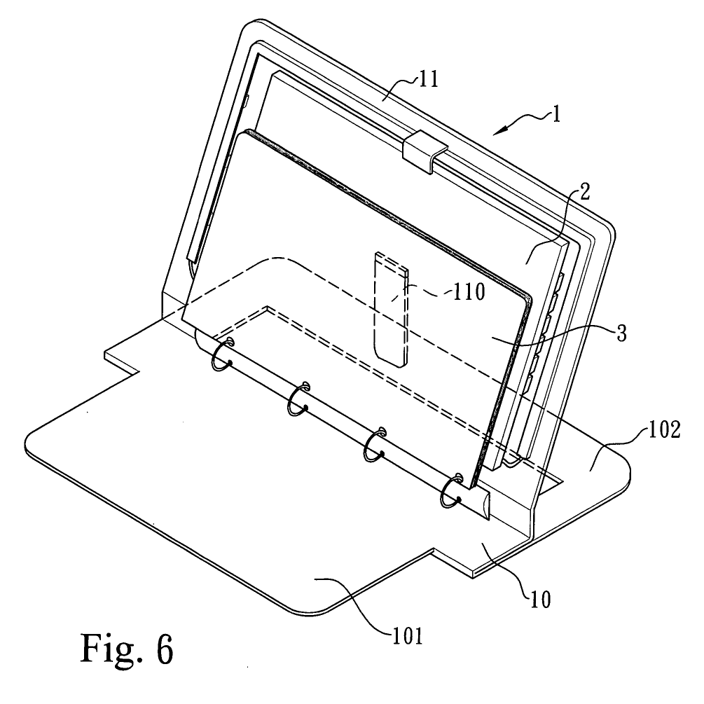

Please refer to FIG. 6, which is a schematic diagram showing the operation on the lap by bending back the bottom plate of the present invention. The bottom plate 10 of the main body 1 is constituted by pivotal connection of a base plate 101 and a backbend plate 102. The backbend plate 102 can be bent back to the backside of the cover plate 11 to lean the support rack 110 against the backbend plate 102 thereby forming a larger and steadier installment surface by using the base plate 101 and the backbend plate 102. Thus, the main body 1 can be put on the lap for operation, which provides the present invention with more mobility.

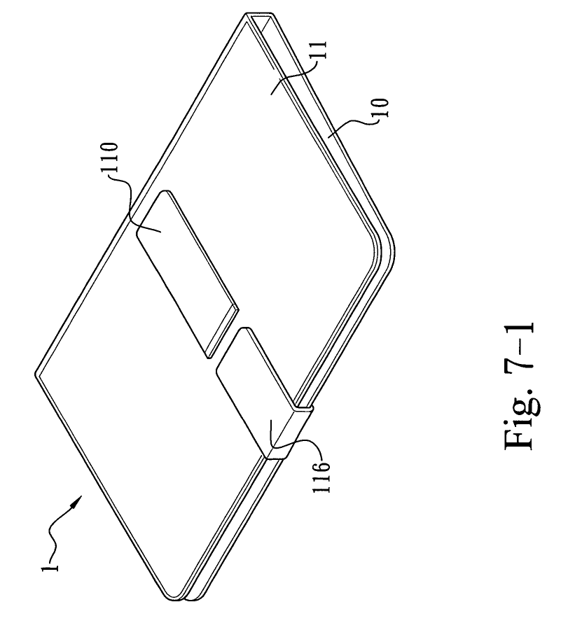

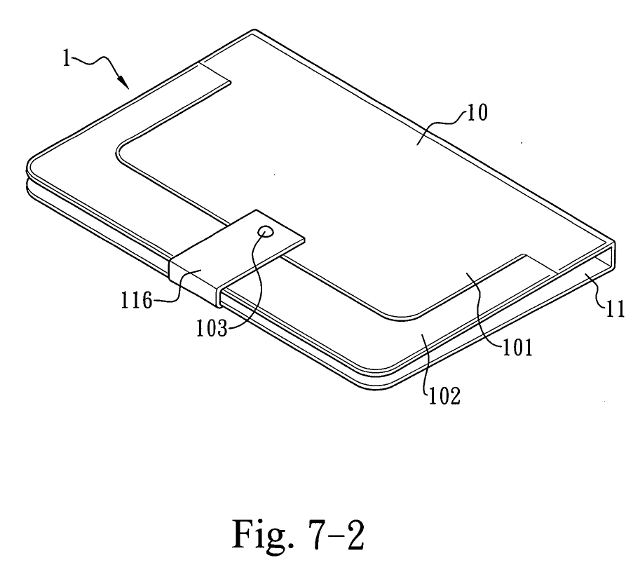

Please refer to FIG. 7-1 and FIG. 7-2, which show a front perspective view and a bottom perspective view of a folded main body of the present invention. A buckle belt 116 is mounted on a cover plate 11 of the main body 1. A buckle 103 is mounted on the bottom plate 10. When the main body 1 is not in use, the cover plate 11 can be folded against the bottom plate 10 by using the buckle belt 116 to clasp the buckle 103 to have a folded notebook form. It is portable, and conserves space.

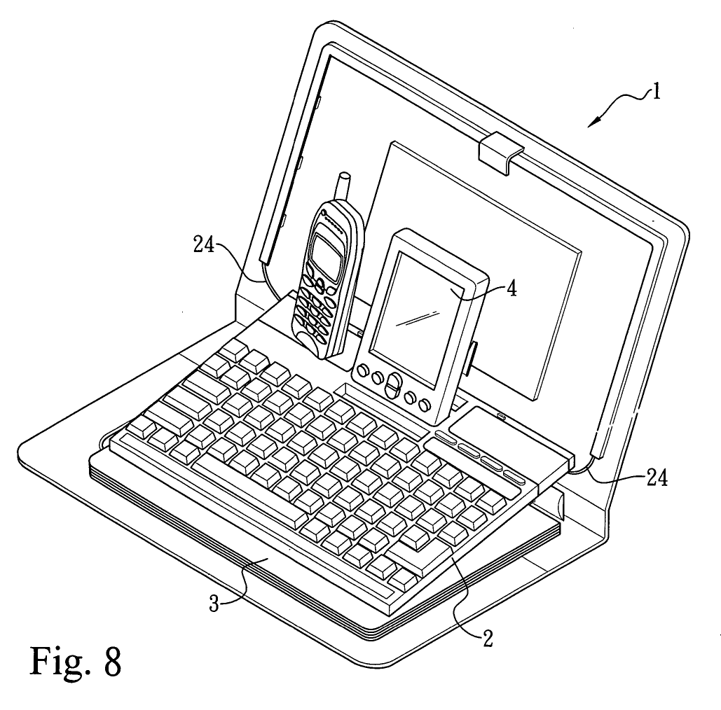

Please refer to FIG. 8, which is a schematic view showing the use status of simultaneously connecting to two handheld electronic apparatuses in accordance with the present invention. An infrared ray transmission line 24 can be mounted at one side of the main body 1 and the keyboard 2 for connection with a handheld electronic apparatus. Moreover, this infrared ray transmission line can be mounted respectively on their both sides for simultaneous connection with two handheld electronic apparatuses, for example, a PDA is connected to its one side and a mobile phone is connected to the other side.

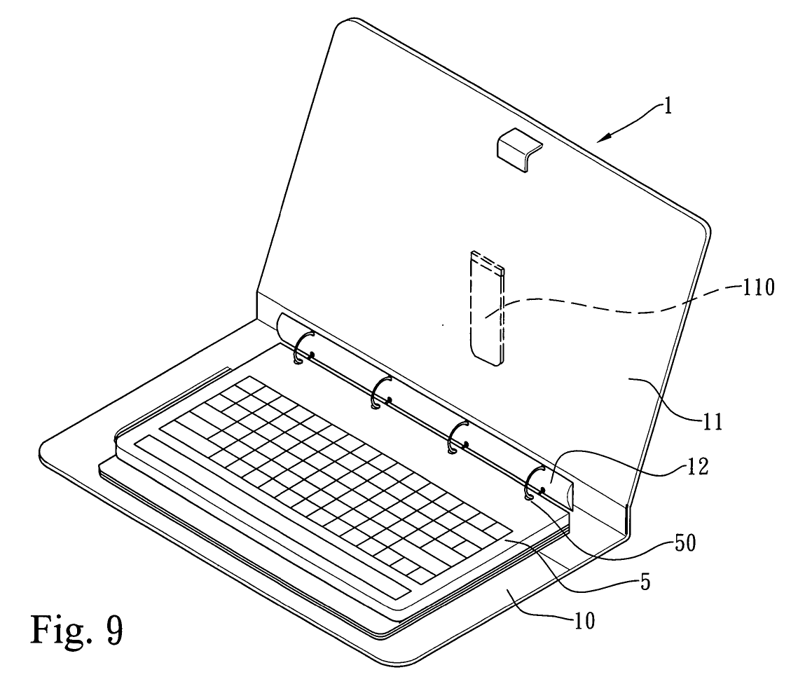

Please refer to FIG. 9, in which a wireless transmission apparatus mounted on the keyboard 2 of the present invention is a bluetooth communication apparatus. A main body 1 in the form of a notebook is provided. The main body 1 comprises a bottom plate 10 and a cover plate 11, which can be folded or unfolded against one another. A support rack 110 is mounted on the main body 1 to provide a support for the unfolded cover plate 11. A C type clip 12 is mounted on the main body 1. Holes 50 are formed on a front end of a removable super thin type bluetooth keyboard 5, thus the bluetooth keyboard 5 can be mounted on the main body 1 by installing the bluetooth keyboard 5 in the C type clip 12 through the holes 50.

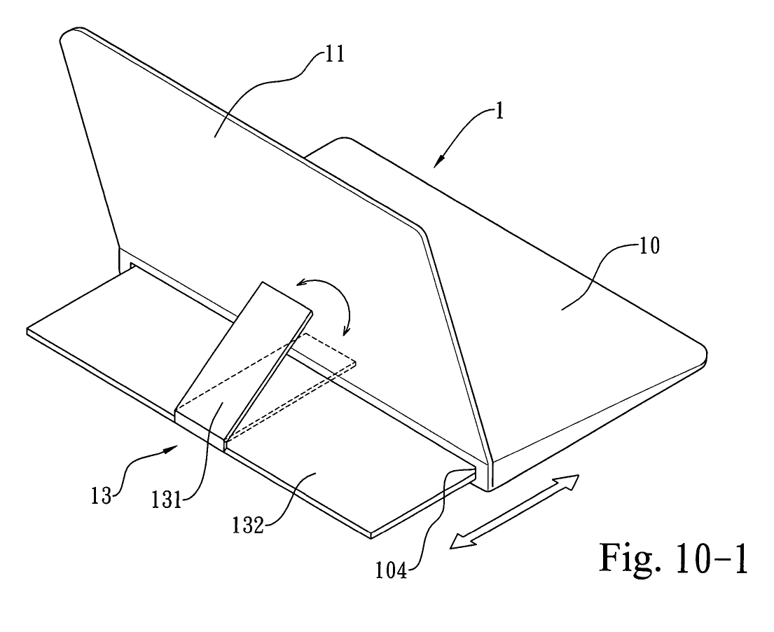

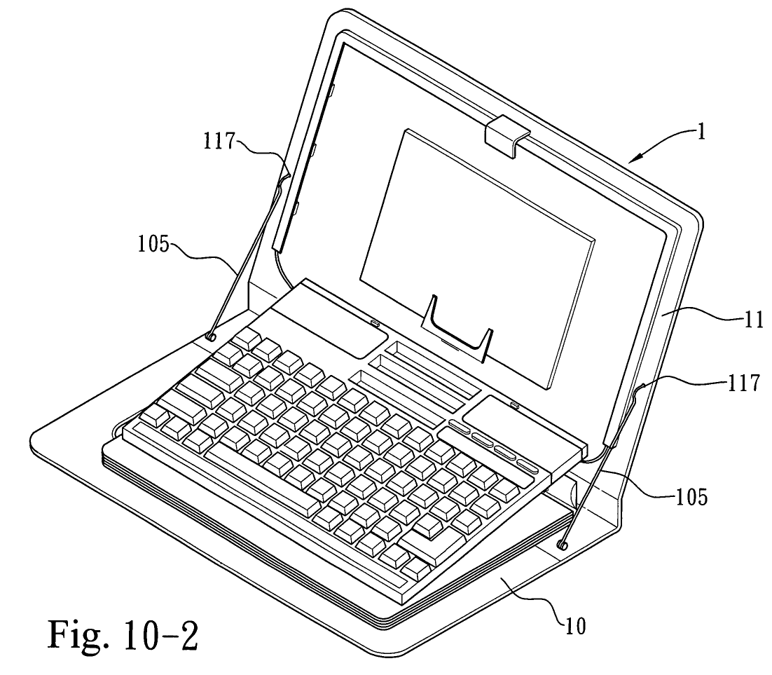

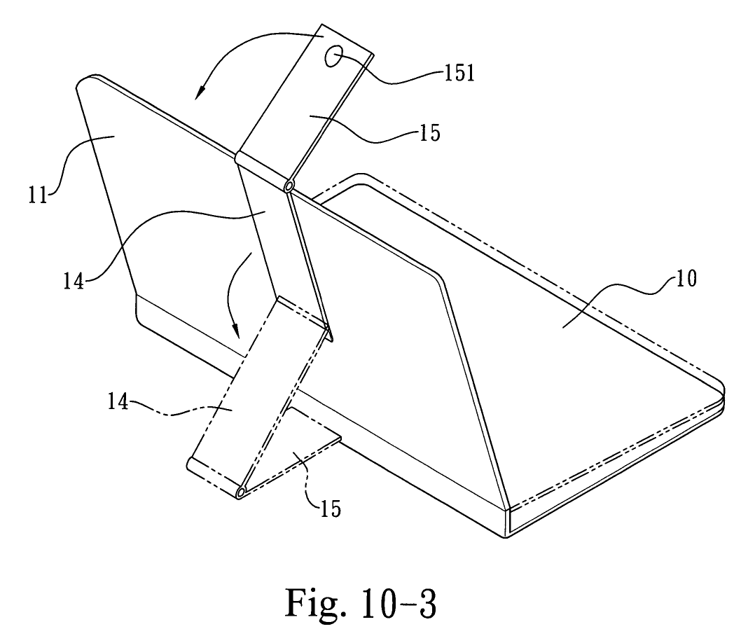

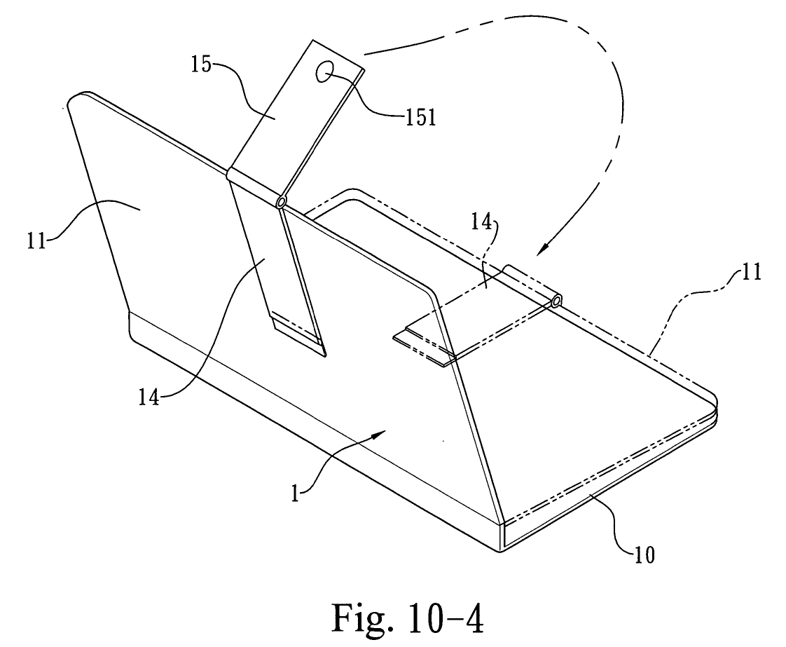

Please refer to FIG. 10-1, besides the aforementioned method for supporting the unfolded main body 1, the support method can be performed in the following manner. A containing space 104 having a support rack 13 is mounted on a bottom of the bottom plate 10, wherein the support rack 13 includes a central pivot pivotally connecting with an upper support plate 131 and a lower support plate 132. When it is needed to support the main body 1, the support 13 is drawn from containing space 104, and the upper support plate 131 is then unfolded to lean against the cover plate 11. When the folding operation is performed, the upper support plate 131 is rotated to fold against the lower support plate 132, and then inserted into the containing space 104 of the bottom plate 10. The lower support plate 132 can be used as a typing support for operation on the lap since it has a larger area.

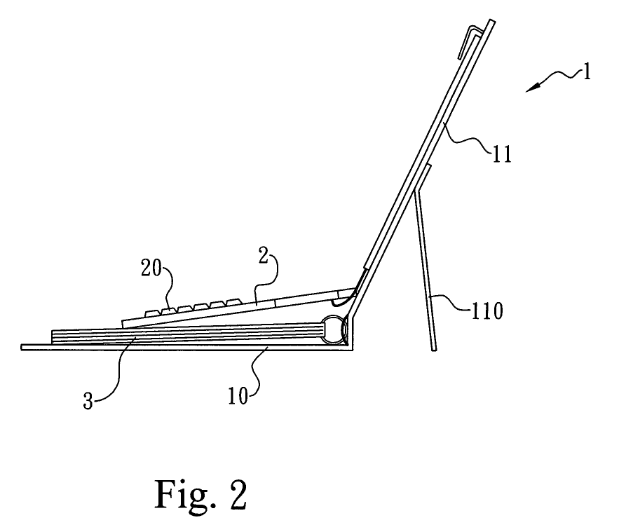

Please refer to FIG. 10-2, which shows another method for supporting the unfolded main body, wherein holes 117 are formed on the cover plate 11, and support shafts 105 are pivotally mounted on the bottom plate 10. When the cover plate 11 is unfolded, the support shafts 105 can be rotated upwardly to hook the holes 117 of the cover plate 11 for supporting the main body 1.

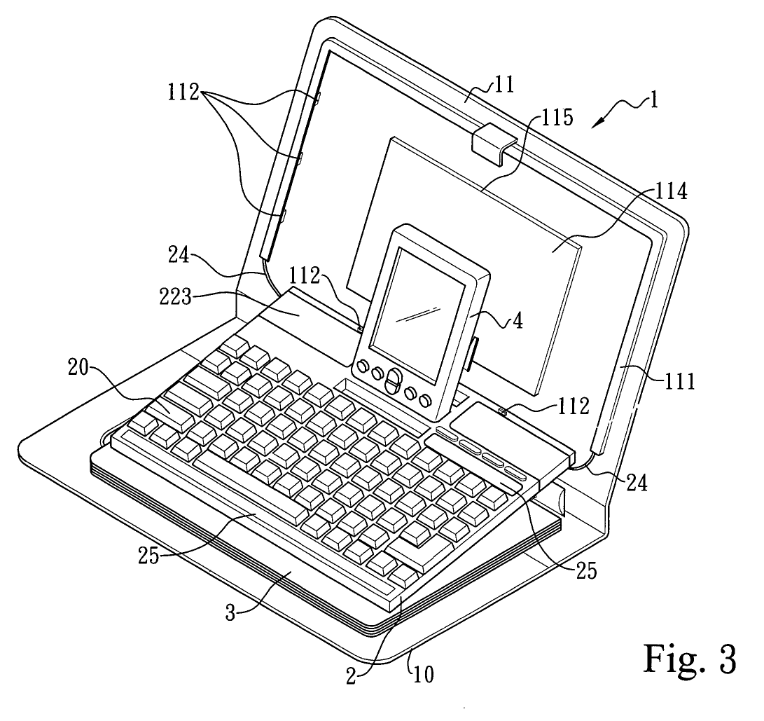

Please refer to FIG. 10-3, which is another embodiment of support method of the present invention, wherein a support rack and a buckle belt are included thereon to provide the support purpose after it is unfolded, and the clasping purpose after it is folded. A support rack 14 is mounted pivotally on the outside of the cover plate 11. The support rack 14 is pivotally connected to a clasping plate 15 through a pivot. A buckle 151 is mounted on the clasping plate 15 to clasp a buckle on the bottom surface of the bottom plate 10. When the cover plate 11 is unfolded, the support rack 14 and the clasping plate 15 are rotated backwardly to enable the clasping plate 15 to be horizontally placed on a surface of a desk, wherein the support rack 14 and the clasping pate 15 are treated as a support framework. As shown in FIG. 10-4, when the main body 1 is folded, the clasping plate 15 can be rotated to clasp the bottom surface of the bottom plate 10 so as to form a portable notebook.

The present invention integrates the notebook with the keyboard by using the aforementioned structures. When the user is out, he merely needs to carry a notebook to enable to write the note and to connect to a handheld electronic apparatus, such as PDA, by using the keyboard for input operation at the same time. Moreover, the present invention can be folded to form a portable and space-saving notebook. When it is used, the main body can be unfolded to form a support framework to facilitate operation of keyboard input, and used to mount the handheld electronic apparatus firmly. It is easy to set up the present invention to have superior utilization and practicability. Besides acting as a support framework, the main body can form a larger setting surface by bending back the backbend plate of the bottom plate for operation on the lap. Thus, the present invention has superior mobility and practicability.

Therefore, as is understood by a person skilled in the art, the present invention achieves the aforementioned purpose according to the above description and satisfies requirements of patent law. The application for a patent is therefore submitted.

As is understood by a person skilled in the art, the foregoing preferred embodiments of the present invention are illustrated of the present invention rather than limiting of the present invention. It is intended that various modifications and similar arrangements be included within the spirit and scope of the appended claims, the scope of which should be accorded the broadest interpretation so as to encompass all such modifications and similar structure.

What the invention claimed is:

1. A notebook type keyboard apparatus, comprising:
a main body in the form of the notebook comprising a bottom plate and a cover plate, wherein the cover plate is folded or unfolded against the bottom plate;
a support rack mounted on the main body to support the unfolded main body for setting the main body on a planar surface; and
a keyboard mounted inside the main body, wherein the keyboard comprises a wireless transmission apparatus for connection with a handheld electronic apparatus.

2. The notebook type keyboard apparatus of claim 1, wherein a notepaper is mounted inside the main body, the support rack is mounted pivotally on an outside of the cover plate for being set on the planar surface, and a containing slot for the handheld electronic apparatus is mounted on the keyboard.

3. The notebook type keyboard apparatus of claim 2, wherein the keyboard enabled to fold against the cover plate by rotation is pivotally mounted on the cover plate, and a binder is mounted on the cover plate for clasping and fixing the keyboard.

4. The notebook type keyboard apparatus of claim 1, wherein the keyboard enabled to fold against the cover plate by rotation is pivotally mounted on the cover plate, and a binder is mounted on the cover plate for clasping and fixing the keyboard.

5. The notebook type keyboard apparatus of claim 1, wherein the wireless transmission apparatus is an infrared ray transmission apparatus, a button region is set on the keyboard, a containing space for an infrared ray transmission line is mounted in a front end of the containing space, a plurality of outstanding wedges are mounted in the containing space for receiving the infrared ray transmission line, and a cover is mounted above the containing space, a connector is mounted on the button region, a trench is mounted on an edge of the cover plate, one terminal of the infrared ray transmission line is coupled with the connector, the line body is fixed in the trench so that a transmitter mounted on the other terminal of the infrared ray transmission line can be fixed in the trench, a plurality of fixers are mounted in the trench for fixing an emission direction of the emitter of the infrared ray transmission line.

6. The notebook type keyboard apparatus of claim 1, wherein the keyboard is a bluetooth keyboard, and the wireless transmission apparatus is a bluetooth communication apparatus.

7. The notebook type keyboard apparatus of claim 6, wherein a C type clip is mounted on the main body, and a hole is formed on the bluetooth keyboard for installing the bluetooth keyboard in the C type clip.

8. The notebook type keyboard apparatus of claim 1, wherein the bottom plate comprises a base plate connecting pivotally with a backbend plate, the backbend plate can be bent back to a backside of the cover plate to lean the support rack against the backbend plate.

9. The notebook type keyboard apparatus of claim 1, wherein at least one function plate is mounted on the keyboard, the function plate can be replaced according to the switch of an operation system.

10. The notebook type keyboard apparatus of claim 1, wherein a bracket is pivotally mounted on an interior surface of the cover plate to support and set the handheld electronic apparatus, and a slide-proof is mounted on the inside surface of the cover plate above the bracket.

11. The notebook type keyboard apparatus of claim 1, wherein a containing space is mounted on a bottom of the bottom plate, the support rack is mounted in the containing space in a removable way, and a central pivot is pivotally connected with an upper support plate and a lower support plate, wherein the upper support plate can be rotated upwardly to lean against an outside of the cover plate.

12. The notebook type keyboard apparatus of claim 1, wherein a hole is formed on the cover plate, and a support shaft is mounted pivotally on the bottom plate, wherein the support shaft can be rotated upwardly to hook the hole of the cover plate for supporting the main body.

13. The notebook type keyboard apparatus of claim 1, wherein the support rack is pivotally connected to an outside of the cover plate, and to a clasping plate through a pivot, wherein a buckle is mounted on the clasping plate to clasp a buckle on the bottom plate.
